(19) United States
(12) Patent Application Publication
(10) Pub. No.: US 2022/0259866 A1
(43) Pub. Date: Aug. 18, 2022

(54) A GLASS FIBRE REINFORCED CONCRETE PANEL

(71) Applicant: SKONTO CONCRETE CLADDING, SIA, Riga (LV)

(72) Inventor: Rihards RAVIS, Riga (LV)

(21) Appl. No.: 17/597,860

(22) PCT Filed: Aug. 23, 2019
(86) PCT No.: PCT/IB2019/057100

§ 371 Date: Jan. 27, 2022

(51) Int. Cl. E04F 13/073; E04F 13/14

(52) U.S. Cl. CPC E04F 13/073; E04F 13/148; E04F 13/147

(57) ABSTRACT

Invention relates to glass fibre reinforced concrete (GRC) panels resembling a brick wall. The present invention is a panel (1) made of glass fibre reinforced concrete (GRC), wherein a inorganic colouring pigment is added to the GRC to acquire distinctive colouring of the GRC panel. A thickness of the GRC panel is in the range from 10 mm to 60 mm, preferably from 10 to 25 mm. A front face (2) of the GRC panel (1) is profiled so to resemble a bricked wall with a brick surfaces (4) and grooves (5) therebetween, wherein a mortar (10) is filled in the grooves (5).

### FIELD OF THE INVENTION

Invention relates to glass fibre reinforced concrete (GRC) panels resembling a brick wall.

### BACKGROUND OF THE INVENTION

United States patent application publication No. US 2008/0196336 discloses a method of forming an exterior wall of a building, including the wall, includes the step of mounting a fibre reinforced panel to the building. The panel has a plurality of masonry units protruding from the face thereof that are spaced from one another with a groove between each of the masonry units. The method includes mounting a second, similar panel to the building spaced from the first panel with a groove therebetween, and injecting mortar into the grooves between the masonry units and the groove between the panels. The mortar covers the grooves between masonry units and the groove between panels.

United States patent application publication No. US2008/0155938 discloses a method of forming an exterior wall of a building, including the finished wall, includes the steps of mounting a cementitious, fibre reinforced panel to the wall and then applying a mortar to the panel. The mortar can be stucco, which is typically painted, or a base to which masonry units, such as stones or bricks, are mounted.

### SUMMARY OF THE INVENTION

The subject of the invention is a panel made of glass fibre reinforced concrete (GRC) also known as GRC panel that is formed during manufacturing in such a shape that it resembles brick wall. The GRC panel is made from GRC that is reinforced with glass fibres, wherein a length of the glass fibres is in the range from 5 to 70 mm, preferably 30 mm. The GRC panel has a front face and a rear face, an upper edge and a lower edge, and side edges. The front face of the GRC panel is profiled so to resemble a bricked wall with a brick surfaces and grooves. The grooves are filled with a mortar. The mortar is injected into the grooves after curing of the GRC panel. The mortar is made of rougher material that the GRC panel and a colour of the mortar is different from a colour of the GRC.

Moreover, a colouring agent or pigment is added to the GRC to acquire distinctive colouring of the GRC panel or distinctive colouring of a brick wall. The colouring pigment may be black pigment such as Bayferrox® 360 or other inorganic pigment having colour index—pigment black 11. Use of inorganic pigment makes GRC panel resistant to fade.

A thickness of the GRC panel may be in the range from 10 mm to 60 mm, preferably from 10 mm to 25 mm.

The GRC panel may be made in different configurations or embodiments. One of the embodiments is a L-type GRC panel. In the following embodiment, the GRC panel comprises a main wall and a side wall extending from the one of the side edges of the GRC panel substantially orthogonal to the front face of the GRC panel, wherein the side wall runs along the entire length of the side edge of the GRC panel. The side wall is integral with a main wall from which it extends.

In another embodiment, the GRC panels is U-type GRC panel. In the following embodiment, the GRC panel comprises a main wall and two side walls where each side wall extends from respective side edge of the panel substantially orthogonal to the front face of the panel, wherein both side walls runs along the entire length of both side edges of the panel. Both side walls are integral with the main wall from which it extends

In another embodiment, the GRC panel may be curved so that it is suitable for cladding curved structures of the building.

The invention also comprises a method for manufacture of aforementioned GRC panel, wherein the method includes the following steps: forming a panel with a brick surfaces and grooves from a glass fibre reinforced concrete (GRC), wherein an inorganic colouring agent is added to the GRC to obtain colouring that resembles a brick colouring; and filling or injecting into the grooves of the GRC panel with a mortar, wherein a colouring of the mortar differs from the colouring of the GRC. The method further comprises a step of attachment or built-in of a frame structure to a rear surface of the GRC panel during curing of the GRC panel. Hence, the frame structure is integral part of the GRC panel.

In detail the method includes the following steps: providing a GRC; adding of an inorganic colouring pigment to the GRC to obtain a colour that resembles a brick colouring; providing a panel mould which surface resemble a brick wall having brick surfaces and groove therebetween; applying the GRC into the panel mould, preferably by spraying; curing the GRC in the panel mould; removing of cured GRC panel from the panel mould; and filling the grooves of the GRC panel with a mortar, wherein a colour of the mortar differs from the colour of the GRC.

The present invention also comprises a method for building exterior wall using the GRC panel that is manufactured by the aforementioned method, wherein the method includes the step of mounting of the GRC panel to the exterior wall of a building by means of the frame structure.

### BRIEF DESCRIPTION OF THE DRAWINGS

FIG. 1 is a perspective view of a panel 1 from a front having two side walls 11.

FIG. 2 is a perspective view a panel 1 from a back having two side walls 11 and attached frame structure 12 thereto.

FIG. 3 is a perspective view of a panel 1 having one side wall 11.

FIG. 4 is a close up view of a cross-section taken along lines A-A from FIG. 3.

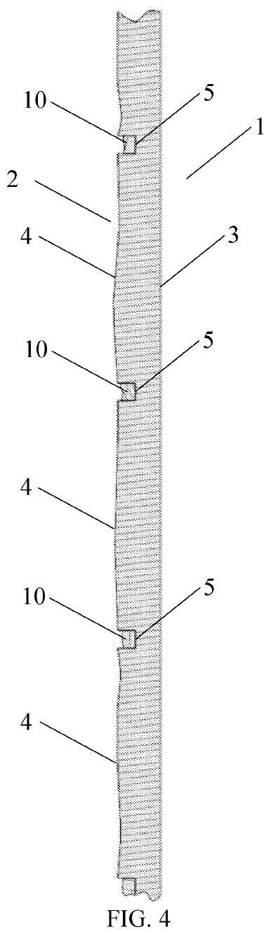

FIG. 5 is a technological process of manufacturing GRC panel 1 resembling a brick wall.

### DETAILED DESCRIPTION OF THE INVENTION

Before explaining the disclosed embodiment of the present invention in detail, it is to be understood that the invention is not limited in its application to the details of the particular arrangements shown, since the invention is capable of other embodiments. Also, the terminology used herein is for the purpose of description and not of limitation.

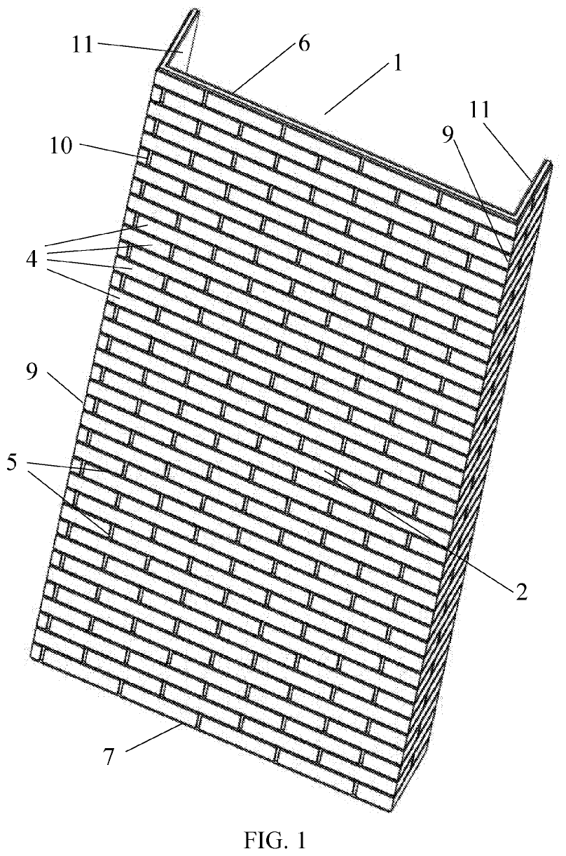

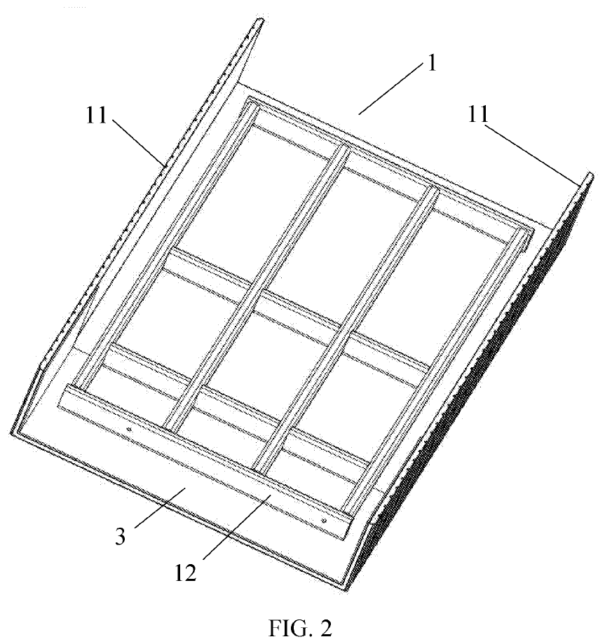

As shown in FIGS. 1 and 2, a panel 1 is made of glass fibre reinforced concrete (GRC). The panel 1 has a front face 2, a rear face 3, an upper edge 6 and a lower edge 7 and side edges 9. The following GRC panel 1 comprises a main wall with side edges 9, from which extends two side walls 11. All three walls are integral. Moreover, the GRC contains an inorganic colouring pigment to provide distinctive colour of the GRC panel and in that a thickness of the GRC panel is 25 mm, and in that the front face 2 of the GRC panel 1 is profiled so to resemble a bricked wall with a brick surfaces 4 and grooves 5 therebetween. The grooves 5 are filled with a mortar 10. Moreover, the mortar 10 is in grey colour but the GRC panel 1 is in red colour, wherein the red colour resembles a red colour of bricks. The GRC panel 1 further comprises a frame structure 12 attached to the rear face 3 of the GRC panel 1.

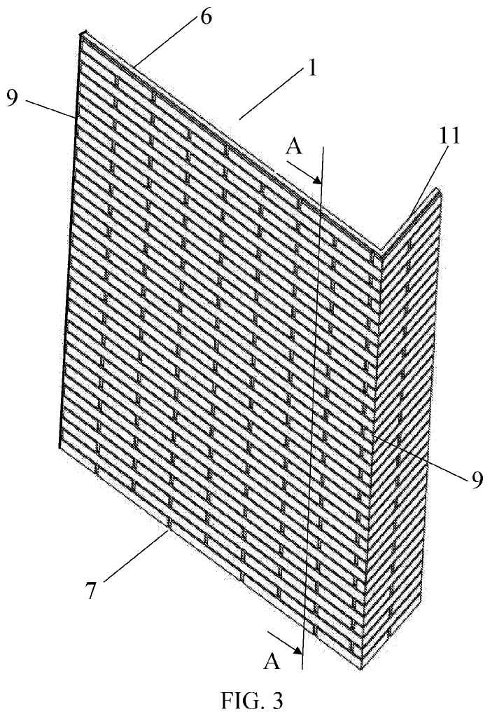

As shown in FIG. 3, a GRC panel 1 comprises one side wall 11 extending from the one of the side edges 9 of the GRC panel 1 substantially orthogonal to the front face 2 of the GRC panel 1, wherein the side wall 11 runs along the entire length of the side edge 9 of the GRC panel 1.

As shown in FIG. 3, is a close up view of a cross-section of the GRC panel 1 taken along lines A-A from FIG. 3a. GRC panel 1 comprises a front face 2 that has formed brick surfaces 4 and grooves 5 resembling brick wall. The grooves are filed with mortar 10.

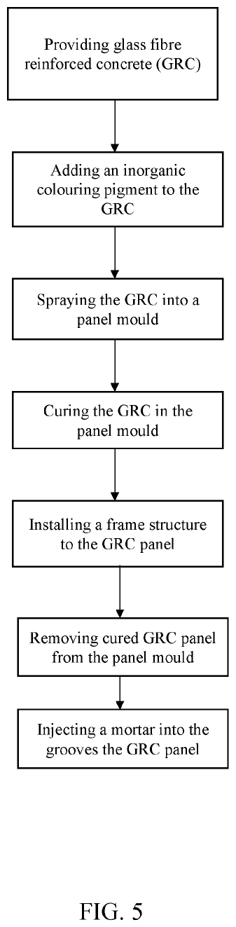

As shown in FIG. 5, is a technological process of manufacturing a panel 1 resembling a brick wall. A method or process of manufacturing aforementioned a panel 1 includes the following steps. The GRC is prepared or provided containing glass fibres. An inorganic colouring pigment is added to the GRC to obtain necessary colour of the GRC. After preparation of the GRC in necessary amount and colour, the GRC is poured into the panel mould having profiled surface that resembles brick wall having brick surface and grooves. When the GRC is filed in the panel mould in necessary amount, the GRC is left for curing. During curing, the frame structure 12 is attached to the rear face 3 of the cured panel, in result of which the frame structure 12 is integrally connected to the rear surface 3 of the panel 1. After curing, the panels 1 is removed from the panel mould. After removal, the grooves 5 are filed with the mortar so that the panel 1 resembles a brick wall.

The invention has been described with reference to various specific and illustrative embodiments and techniques. However, one skilled in the art will recognize that many variations and modifications may be made while remaining within the scope of the invention as defined in the appended claims.

### LIST OF REFERENCES

1—a panel;
2—a front face;
3—a rear face;
4—a brick surface;
5—a groove;
6—an upper edge;
7—a lower edge;
9—a side edge;
10—a mortar;
11—a side wall; and
12—a frame structure.

1. A panel (1) made of glass fibre reinforced concrete (GRC), having a front face (2) and a rear face (3), characterized in that an inorganic colouring pigment is added to the GRC to acquire distinctive colour of the GRC panel resembling a brick wall, and in that a thickness of the GRC panel is in the range from 10 mm to 60 mm, preferably from 10 to 25 mm, and in that the front face (2) of the GRC panel (1) is profiled so to resemble a bricked wall with a brick surfaces (4) and grooves (5) therebetween, and in that a mortar (10) is filled in the grooves (5) and a colour of the mortar (10) differs from a colour of the GRC.

2. The panel (1) according to claim 1, characterized in that the inorganic colouring pigment has colour index of pigment black 11.

3. The panel (1) according to claim 1, characterized in that a length of the glass fibres in the GRC, from which the GRC panel (1) is made, is in the range from 2 to 70 mm, preferably 30 mm.

4. The panel (1) according to claim 1 characterized in that it further comprises a side wall (11) extending from the one of the side edges (9) of the GRC panel (1) substantially orthogonal to the front face (2) of the GRC panel (1), wherein the side wall (11) runs along the entire length of the side edge (9) of the GRC panel (1).

5. The panel (1) according to claim 4 characterized in that it further comprises two side walls (11) where each side wall (11) extends from respective side edge (9) of the GRC panel (1) substantially orthogonal to the front face (2) of the GRC panel (1), wherein both side walls (11) runs along the entire length of both side edges (9) of the GRC panel (1).

6. The panel (1) according to claim 1 characterized in that the GRC panel (1) is curved.

7. A method for manufacture of a panel (1) according to claim 1, wherein the method includes the following steps:
providing a glass fibre reinforced concrete (GRC);
adding of an inorganic colouring pigment to the GRC to obtain a colour that resembles a brick colouring;
providing a panel mould which surface resemble a brick wall having brick surfaces and groove therebetween;
applying the GRC into the panel mould, preferably by spraying;
curing the GRC in the panel mould;
removing of cured GRC panel from the panel mould; and
filling the grooves (5) of the GRC panel (1) with a mortar (10), wherein a colour of the mortar (10) differs from the colour of the GRC.

8. A method for manufacture of a panel (1) according to claim 7, wherein the method comprises a step of attachment of a frame structure (12) to a rear surface (3) of GRC panel (1) during curing of the GRC panel.

9. A method for building exterior wall using the GRC panel (1) according to claim 1 that is manufactured by the method according to claim 7, wherein the method includes the step of mounting of the GRC panel (1) to the exterior wall of a building by means of the frame structure (12).
